(19) United States
(12) Patent Application Publication
(10) Pub. No.: US 2015/0084765 A1
(43) Pub. Date: Mar. 26, 2015

(54) INTELLIGENT SMOKE SENSOR

(71) Applicant: Fibar Group sp. z o.o., Poznan (PL)

(72) Inventors: Maciej Fiedler, Poznan (PL); Bartlomiej Arcichowski, Poznan (PL); Adam Pudlowski, Kutno (PL)

(21) Appl. No.: 14/494,730

(22) Filed: Sep. 24, 2014

Related U.S. Application Data
(60) Provisional application No. 61/881,808, filed on Sep. 24, 2013.

(51) Int. Cl. G08B 17/10; G08B 29/14

(52) U.S. Cl. CPC G08B 17/10; G08B 29/14
USPC 340/506; 340/517

(57) ABSTRACT

Method and/or system for an intelligent smoke sensor may comprise a sensor system configured to detect at least one of a plurality of predefined conditions, a processor coupled to the sensor system. The processor may be configured to generate an alarm indication in response to having detected at least one predefined condition. The intelligent smoke sensor system may comprise a recorder coupled to the processor. The recorder may be configured to record the alarm indication and the detected predefined conditions. The intelligent smoke sensor may comprise communication circuitry that mat be configured to communicate the alarm indication and the detected predefined condition to the network.

### CLAIM OF PRIORITY/INCORPORATION BY REFERENCE

This patent application makes reference to, claims priority to and claims benefit from U.S. Provisional Patent Application Ser. No. 61/881,808 entitled “Intelligent Smoke Sensor” filed on Sep. 24, 2013, which is hereby incorporated herein by reference in its entirety.

### TECHNICAL FIELD

Aspects of the present disclosure relate to electronic systems and/or networking More specifically, certain implementations of the present disclosure relate to an intelligent smoke sensor.

### BACKGROUND

Existing methods and systems for providing smoke detection can be costly, cumbersome and inefficient. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for an intelligent smoke sensor, substantially as shown in and/or described in connection with at least one of the figures, as set forth more completely in the disclosure and/or the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 illustrates an example home network.

FIG. 2 illustrates an example intelligent smoke sensor.

FIG. 3 illustrates an example flow chart of a method for an example process for managing one or more intelligent smoke sensors.

### DETAILED DESCRIPTION

Certain implementations may be found in a method and system for an intelligent smoke sensor. An exemplary embodiment provides an intelligent smoke detecting system for use in a network. The intelligent smoke detecting system includes a sensor system to detect at least one of a plurality of predefined conditions. The intelligent smoke detecting system also includes a processor coupled to the sensor system to generate an alarm indication in response to the sensor system having detected at least one of the predefined conditions. The intelligent smoke detecting system also includes a recorder coupled to the processor to record the alarm indication and the detected at least one of the predefined conditions, and a communication circuitry to communicate the alarm indication and the detected at least one of the predefined conditions to the network.

Another exemplary embodiment provides an intelligent smoke detecting system for use in a network. The intelligent smoke detecting system includes a device communicatively coupled to the network, and a network manager communicatively coupled to the device to communicate control signals via the network. The intelligent smoke detecting system also includes an intelligent smoke sensor communicatively coupled to the network manager via the network. The intelligent smoke sensor houses therein a sensor system to detect at least one of a plurality of predefined conditions, a processor coupled to the sensor system to generate an alarm indication in response to the sensor system having detected at least one of the predefined conditions, and a recorder coupled to the processor to record the alarm indication and the detected at least one of the predefined conditions, and a communication circuitry to communicate the alarm indication to the network manager via the network. The network manager further communicates the control signals to the device in response to receiving the alarm indication. The device is activated in response to receiving the control signals.

Another exemplary embodiment provides a method of controlling a device via a) an intelligent smoke detecting system being remote from the device, and b) a network manager operable to communicate control signals to the device. The method includes detecting at the intelligent smoke detecting system at least one of a plurality of predefined conditions. In response to having detected the at least one of the predefined conditions, the method includes generating an alarm indication, recording the alarm indication and the at least one of the predefined conditions, and communicating the alarm indication from the intelligent smoke detecting system to the network manager. The method also includes communicating the control signals from the network manager to the device in response to the network manager receiving the alarm indication, and activating the device in response to receiving the control signals.

As utilized herein the terms “circuits” and “circuitry” refer to physical electronic components (i.e. hardware) and any software and/or firmware (“code”) which may configure the hardware, be executed by the hardware, and/or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and/or “module” refer to functions than may be performed by one or more circuits. As utilized herein, the term “example” means serving as a non-limiting example, instance, or illustration. As utilized herein, the terms “for example” and “e.g.” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

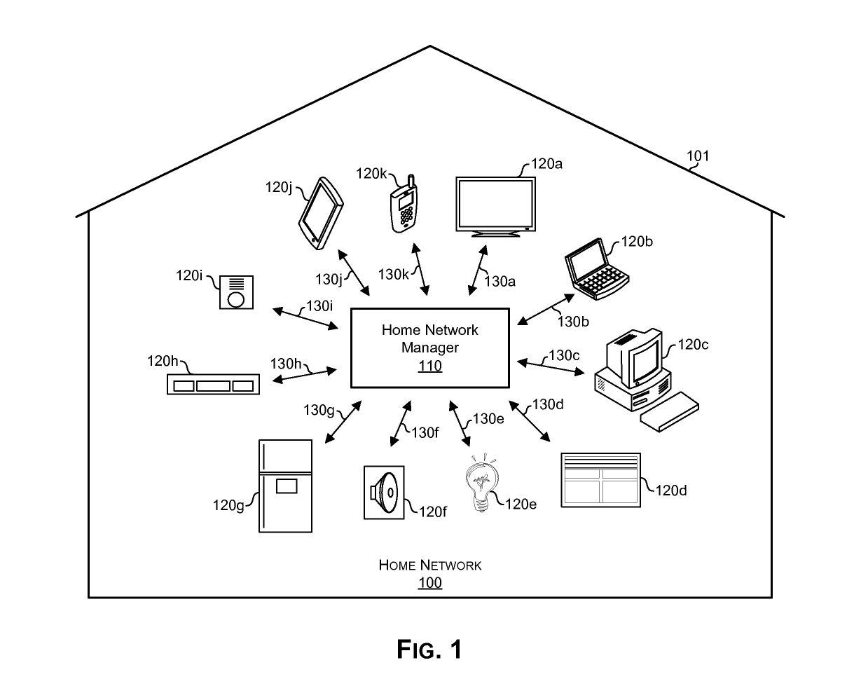

FIG. 1 illustrates an example home network. Referring to FIG. 1, there is shown a home network 100.

The home network 100 may correspond to a location 101. The location 101 may, for example, correspond to a residence (e.g., home, apartment) or non-residence premises (e.g., a small business, a school, a library). In this regard, the home network 100 may, for example, comprise a plurality of home network elements, such as, for example, a plurality of home network elements 120a-120k. The home network elements (e.g., home network elements 120a-120k) may, for example, comprise one or more devices, systems, fixtures, appliances, and/or other circuitry. The home network elements (e.g., home network elements 120a-120k) may comprise, for example, one or more televisions 120a, one or more computers (e.g., laptop computer 120b, desktop computer 120c), one or more personal handheld devices (e.g., tablet 130j, mobile phone 130k), one or more multimedia devices and/or components (e.g., speakers 120f), one or more structural fixtures (e.g., windows/window blinds 120d), one or more lighting and/or electrical fixtures 120e, one or more appliances (e.g., refrigerator 120g), one or more environmental sensory devices 120h (e.g., thermometers, humidity meters), and/or one or more security devices 120i (e.g., a smoke detector, a carbon monoxide detector, a security alarm, a motion detector).

The disclosure is not limited to any particular type of a home network. Furthermore, the disclosure is not limited to any particular combination of home network elements. It is to be understood that although the network is referred to as a “home network” throughout the disclosure, the disclosure is not limited in this way. Specifically, the network may comprise any other network that may be operable to control one or more network elements.

In some instances, the home network 100 may incorporate a home network manager 110. The home network manager 110 may comprise suitable circuitry, interfaces, logic, and/or code for implementing various aspects of the present disclosure. For example, the home network manager 110 may be configured for use in managing, servicing, and/or interacting with one or more home network elements. Although the home network manager 110 is shown in FIG. 1 as a single and separate device, the disclosure is not limited in this way. For example, in some implementations, one or more functions of the home network manager 110 may be provided by one or more existing home network elements (e.g., providing user interface via tablet 120j and/or television 120a). In an example embodiment of the disclosure, the home network manager 110 may be implemented as a virtual platform, such as, for example, one or more software modules may run on, and/or utilize resources of one or more existing home network elements (e.g., laptop 120b or desktop 120c).

The home network manager 110 may be configured to communicate with one or more elements (e.g., home network devices) in a home network. In an example embodiment of the disclosure, the home network manager 110 may be operable to communicate with one or more devices and/or systems that may be external to a home network, using, for example, optical, wired and/or wireless communication links.

The home network manager 110 may interact with one or more of the home network elements 120a-120k via corresponding links 130a-130k, which may be supported by the home network manager 110 and/or the corresponding home network element(s). For example, the links 130a-130k may be implemented and/or configured to operate using a wireless protocol, such as, for example, a Z-wave protocol. In an example embodiment of the disclosure, the home network 100 may be implemented as Z-Wave network. However, the disclosure is not limited in this way. For example, the home network 110 may comprise one or more wired and/or wireless links and/or protocol. Wireless links and/or protocols, may comprise, for example, WPAN (e.g., Bluetooth or ZigBee) and/or WLAN (WiFi/802.11) protocols and/or any other wireless links and/or protocols suitable for implementation consistent with the disclosure. Wired protocols and/or links may comprise, for example, Ethernet, Universal Serial Bus (USB), and/or any other wired links and/or protocols suitable for implementation consistent with the disclosure.

In an example implementation of the disclosure, the home network manager 110 may be operable to support one or more communication methods from one or more home network devices (e.g., home network elements 120a-120k). For example, one or more home network elements may communicate with the home network manager 110 utilizing a particular wireless link and/or protocol (e.g., Z-wave) and/or a particular wired link and/or protocol (e.g., Ethernet), while one or more other home network elements may communicate with the home network manager 110 utilizing a different particular wireless link and/or protocol (e.g., WiFi) and/or a different particular wired link and/or protocol (e.g., USB).

In an example embodiment of the disclosure, the same one or more home network elements may communicate with the home network manager 110 by, for example, using one or more wired and/or wireless links and/or protocols at the same and/or at different times. For example, a particular network element may communicate with the home network manager 110 using a Z-Wave communication protocol for a particular communication and may communicate with the home network manager 110 using a WiFi communication protocol for another particular communication.

In operation, the home network manager 110 may be operable to manage a home network (e.g., the home network 100). The home network manager 110 may be utilized, for example, as an interface platform for interacting with various network elements (e.g., the home network elements 120a-120k). In this regard, the home network manager 110 may support establishing and/or configuring one or more communication connections/links (e.g., the links 130a-130k) with the one or more elements of the home network 110. Once established, the connectivity between the home network manager 110 and the home network elements (e.g., elements 120a-120k) may, for example, be utilized to enable centralized monitoring, control, and/or management of the home network elements, and/or of the home network 100 as a whole. For example, the home network manager 110 may be operable to control operations of certain elements (e.g., turn on television 120a, switch to particular channel(s) at particular days/times, and/or record if recording is supported); monitor environment in the home network, such as by obtaining environmental readings (e.g., temperature, humidity, etc.) via example environmental sensory devices 120h, and may process these readings (e.g., to determine if/when to adjust other home network elements accordingly); adjust one or more example lighting and/or electrical fixtures 120e (e.g., turn lights on or off); lower/raise example window (blinds) 120d; adjust operations of example appliances (e.g., refrigerator 120g), such as, for example, based on a pre-configured power efficiency/optimization profile; monitor for any indications of a security/safety problem, based on, for example, input from example security devices 120i, and/or act accordingly (e.g., send notifications to users, such as by texting example smartphone 120k, and/or automatically notify authorities, e.g., by dialing ‘911’ and/or contacting pre-configured emergency numbers).

In an example embodiment of the disclosure, the home network manager 110 may provide and/or utilize user interface services in the home network. In this regard, the home network manager 110 may be operable to support use of user interface functions, and/or to generate and/or store information corresponding thereto, which may be utilized to enable interactions between the home network manager 110 and users (e.g., in the home network 100). For example, in some implementations, the home network manager 110 may be configured to generate and/or use a graphic user interface (GUI), for visually displaying information and/or providing interactivity with users (e.g., for providing input thereby). One or more user interfaces may enable configuring the home network manager 110 and/or functions provided by the home network manager 110. In an example embodiment of the disclosure, the one or more user interfaces may enable user interaction with, configuring and/or adjusting other elements in the home network 100 (e.g., elements connected to the home network manager 110).

In an example embodiment of the disclosure, the user interfaces may be provided via one or more other devices that may be communicatively coupled to the home network manager 110. For example, a GUI generated and/or used by the home network manager 110 may be displayed using existing home network elements, such as, for example, television 120a, laptop 120b, tablet 120j, and/or smartphone 120k.

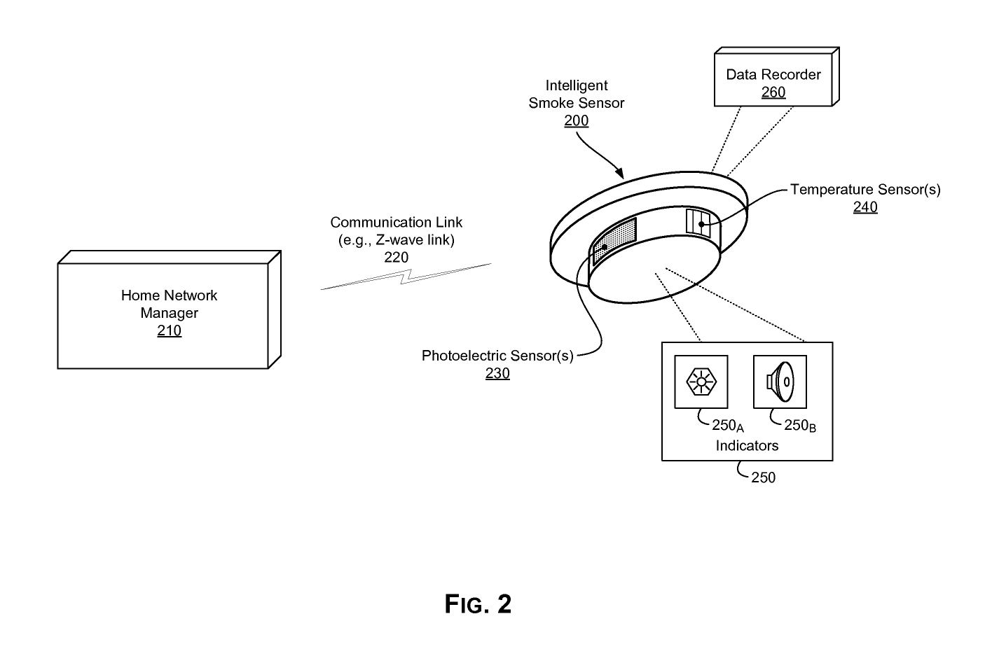

In an example embodiment of the disclosure, one or more home network elements (e.g., home network elements 120a-120k) may be configured to provide enhanced functionality, especially in the context of the home network provided by home network managers (e.g., the home network manager 110). For example, rather than utilize a typical smoke detector, an enhanced (intelligent) smoke sensor may be utilized, such as to provide enhanced monitoring (e.g., better detection), improved recording of information relating thereto, and/or other functions. An example intelligent smoke sensor is depicted in and/or described with respect to FIG. 2.

FIG. 2 illustrates an example intelligent smoke sensor. Referring to FIG. 2, there is shown an intelligent smoke sensor 200.

The intelligent smoke sensor 200 may comprise suitable circuitry, interfaces, logic, and/or code for implementing various aspects of the present disclosure. In particular, the intelligent smoke sensor 200 may be implemented and/or configured to provide enhanced functionality, such as with respect to monitoring and/or detection of, e.g., carbon monoxide, smoke, and/or fire; and/or with respect to recording and/or maintaining of information related thereto. For example, the intelligent smoke sensor 200 may be configured for operation on a home network (e.g., home network 100 as depicted in and/or described with respect to FIG. 1), such that, the intelligent smoke sensor 200 may be utilized as a home network element. In this regard, the intelligent smoke sensor 200 may be configured to interact, for example, in a home network (e.g., home network 100 as depicted in and/or described with respect to FIG. 1) with, for example, a home network manager (e.g., network manager 210). The home network manager may be substantially similar to the home network manager 110 as depicted in and/or described with respect to FIG. 1.

For example, the intelligent smoke sensor 200 may be configured to interact with the home network manager 210 via a communication link 220. The communication link may, for example, comprise a Z-Wave link. In this regard, the intelligent smoke sensor 200 may incorporate a built-in communication transceiver (e.g., a Z-Wave transceiver) and/or related processing resources for allowing use of intelligent smoke sensor. The disclosure is not limited to any particular type of a communication link. For example, the intelligent smoke sensor 200 may be implemented to support, for example one or more wireless and/or wired links, protocols and/or connections. For example, wireless links, protocols and/or connections, may comprise, for example, WPAN (e.g., Bluetooth or ZigBee) and/or WLAN (WiFi/802.11) protocols and/or any other wireless links, protocols and/or connections suitable for implementation consistent with the disclosure. Wired links, protocols and/or connections may comprise, for example, Ethernet, Universal Serial Bus (USB), and/or any other wired links, protocols and/or connections suitable for implementation consistent with the disclosure.

In an example embodiment of the disclosure, the intelligent smoke sensor 200 may be operable to be used with any standard and/or customized alarm system, for example, by utilizing a direct and/or indirect wired connection to the alarm system (e.g., in lieu of and/or in addition to any other wired and/or wireless links and/or connections for communicating with, for example, a home network manager).

The intelligent smoke sensor 200 may incorporate various features for providing enhanced functionality and/or operations. For example, the intelligent smoke sensor 200 may be designed and/or built as an ultra-light device, with efficient and reliable power supply (e.g., driving power directly from electrical grid, and/or by incorporating efficient and/or long lasting 12/24 VDC batteries and/or other batteries and/or power sources). The intelligent smoke sensor 200 may, for example, incorporate one or more sensors. The one or more sensors may be operable to enhance, for example, the smoke/fire/carbon monoxide monitoring and/or detection functions of the intelligent smoke sensor 200. For example, the intelligent smoke sensor 200 may incorporate one or more photoelectric sensors 230 and/or one or more temperature sensors 240. The one or more photoelectric sensors 230 and/or the one or more temperature sensors 240 may provide enhanced detectability of smoke/fire/carbon monoxide, for maximum protection from flaming and/or smoldering fires.

In an example embodiment of the disclosure, the intelligent smoke sensor 200 may incorporate one or more alarm indicators. The one or more alarm indicators may be provided to ensure that the users are more likely alarmed of detected smoke/fire/carbon monoxide. For example, the intelligent smoke sensor 200 may incorporate one or more alarm indicators 250, which may comprise both a visual (e.g., RGB) indicator 250_{A} and an audio (e.g., 100 dBm built-in siren) indicator 250_{B}.

In an example embodiment of the disclosure, the intelligent smoke sensor 200 may be built utilizing a metal screen (not shown) that may go around the edges of the intelligent smoke sensor 200. In this regard, the metal film may comprise beveled microscopic holes (e.g., the holes may comprise rounded edges) that may allow for an enhanced penetration of the smoke into a smoke chamber (not shown) housed within the intelligent smoke sensor 200 such that, for example, the intelligent smoke sensor 200 may be operable to detect presence of smoke (utilizing various sensors) more accurately (e.g., faster) as compared with traditional smoke detectors.

In an example embodiment of the disclosure, the intelligent smoke sensor 200 may incorporate a wireless range tester (not shown) that may be operable to, for example, determine whether the intelligent smoke sensor 200 is within a range of a home network manager (e.g., home network manager 210). In this regard, the intelligent smoke sensor 200 may be operable to generate an alarm condition when the intelligent smoke sensor 200 is not within a rage on any home network manager (e.g., home network manager 210) and/or when the intelligent smoke sensor 200 that, for example, was previously within the range of a (e.g., home network manager 210), is now outside of that range. In an example embodiment of the disclosure, the alarm condition may active one or more alarm indicators (e.g., alarm indicators 250_{A}, 250_{B}) to generate indicate an alarm condition by, for example, generating an audible and/or a visual alarm.

In another example embodiment of the disclosure, the home network manager 210 may be operable to generate an alarm condition, when for example, the intelligent smoke sensor that, for example, was previously within the range of the home network manager 210, is now outside of that range.

In an example embodiment of the disclosure, the intelligent smoke sensor 200 may incorporate one or more various features for, for example, particularly providing (and enhancing) recording and/or maintaining of information (e.g., information relating to alarms, alarm conditions and/or detection of smoke/fire/carbon monoxide). For example, the intelligent smoke sensor 200 may incorporate, for example, a data recorder 260. The data recorder 260 may be operable to record data and/or information relating to operation of the intelligent smoke sensor 200. In this regard, the data recorder 260 may comprise suitable circuitry, interfaces, logic, and/or code for obtaining, processing and/or storing of data and/or information. The data and/or information may be related to operation of the intelligent smoke sensor 200 and/or any detected alarms and/or alarm conditions. The recording and/or storing of data may be done in, for example, a continuous manner, periodically, or it may be event-triggered (e.g., whenever an alarm-triggering event is detected).

The alarm-triggering event may comprise, for example, an increase in temperature (e.g., above a pre-defined and/or per-configured threshold(s), rapid increase of temperature, such as, for example, a raise in temperature by more than a pre-defined and/or pre-configured number of degrees during a pre-defined and/or pre-configured time interval), detection of carbon monoxide, detection of smoke, and/or detection of fire.

In some instances, the data recorder 260 may be specifically designed and/or built to survive a fire incident. For example, the data and/or information stored in the data recorder 260 may be recoverable from the data recorder 260 even when, for example, the intelligent smoke sensor 200 is otherwise destroyed during a fire event. Accordingly, the data and/or information regarding a fire event may be recovered and/or used subsequently to a fire event. The data and/or information may be relevant to, for example, investigating one or more causes of the fire event. For example, the data and/or information may comprise the time and date information of when an alarm condition was triggered and/or the temperature measurements before and throughout the fire even (e.g., for determining how rapidly the fire started and/or how rapidly the temperature was rising, whether a fire, carbon monoxide and/or smoke triggered an alarm condition).

In an example embodiment of the disclosure, the intelligent smoke sensor 200 may comprise other suitable circuitry, interfaces, logic, and/or code for implementing various aspects of the present disclosure. For example, the intelligent smoke sensor 200 may comprise a memory and/or a processor.

The memory may store, for example, configuration data, which may comprise parameters and/or code, comprising software and/or firmware. The memory may comprise different memory technologies, including, for example, read-only memory (ROM), random access memory (RAM), low latency nonvolatile memory, flash memory, solid-state drive (SSD), field-programmable gate array (FPGA), and/or other suitable electronic data storage capable of storing data, code and/or other information.

In an example embodiment of the disclosure, the intelligent smoke sensor 200 may be operable to receive software and/or firmware updates. For example, the intelligent smoke sensor 200 may receive software and/or firmware updates from a network manager (e.g., the home network manager 210). In an example embodiment of the disclosure the software and/or hardware updates may be received, processed and/or installed automatically and/or manually. For example, the process may be completely automatic (e.g., a network manager may send an update to the intelligent smoke sensor and the intelligent smoke sensor may process it automatically), semi-automatic (e.g., an update may be initiated by a user through, for example, a network manager and/or through an interface on the intelligent smoke sensor, and may, for example, be processed by the intelligent smoke sensor automatically) and/or manual (e.g., an update may be initiated by a user through, for example, a network manager and/or through an interface on the intelligent smoke sensor, and may, for example, be processed by the intelligent smoke sensor in response to a user action indicative of a desire to install the particular update (e.g., through an interface)).

The processor may comprise suitable circuitry, interfaces, logic, and/or code that may be operable to process data, and/or control and/or manage components, operations and/or functions of intelligent smoke sensor 200, and/or tasks performed therein. In this regard, the processor may configure and/or control operations of various components and/or subsystems of the intelligent smoke sensor 200, such as, for example, the memory, the communication subsystem (e.g., for communicating with, for example, the home network manager 210), the photoelectric sensor(s) 230, the temperature sensor(s) 240 and/or the indicators 250_{A}, 250_{B}, etc. by utilizing, one or more control signals.

In some embodiments, the processor may also automatically detect a malfunction, for example, when the smoke chamber is damaged. For example, the processor may perform a self test periodically, for example, every 5 seconds. If the processor detects a malfunction, the processor may generate an intermittent sound alarm through the indicator 250B. In other embodiments, the processor may also activate both of the indicators 250A and 250B, that is, both visually through the RGB indicator 250A and audibly through the alarm indicator 250B. In some embodiments, the processor may also transmit an alarm signal via the Z-Wave communication protocol to the network manager and any of the associated devices (120a-120k).

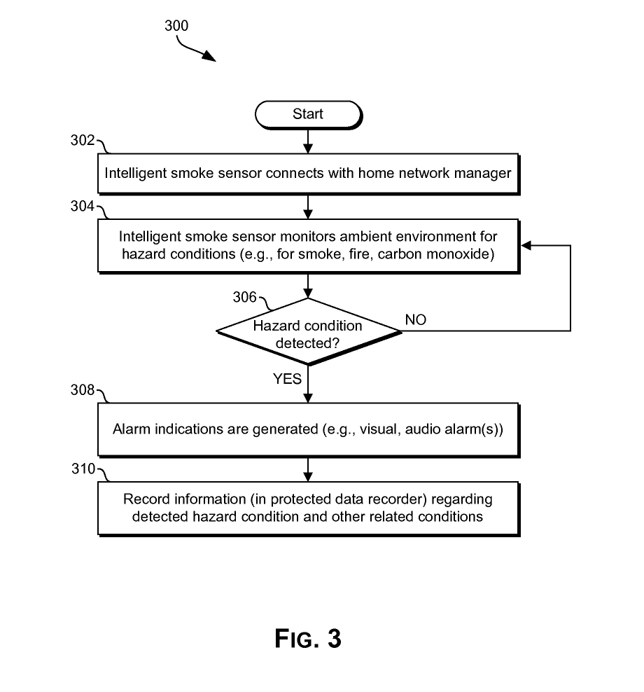

FIG. 3 illustrates an example flow chart of a method for an example process for managing one or more intelligent smoke sensors. Referring to FIG. 3, there is shown a flow chart 300 comprising a plurality of example steps.

In example step 302, an intelligent smoke sensor (e.g., the intelligent smoke sensor 200 as depicted in and/or described with respect to FIG. 2) may connect with a home network manager (e.g., the home network manager 210 as depicted in and/or described with respect to FIG. 2). The connection may comprise a communication link (e.g., the communication link 220 as depicted in and/or described with respect to FIG. 2), such as, for example, a Z-Wave link. The connection may comprise one or more types of wireless and/or wired connections. The connecting may, in some instances, comprise determining whether the intelligent smoke sensor is within range of the home network manager. In this regard, the intelligent smoke sensor may incorporate a wireless range tester for determining whether the intelligent smoke sensor is within a range of a home network manager as described with respect to FIG. 2, for example.

In example step 304, the intelligent smoke sensor may monitor ambient environment close thereto for various hazard conditions, which may comprise, for example, smoke, fire, carbon monoxide and/or other conditions. In this regard, the intelligent smoke sensor may utilize one or more sensors, such as, for example, temperature sensor(s) and/or photoelectric sensor(s), such as for example, sensors depicted in and/or described with respect to FIG. 2.

In example step 306, it may be determined whether a hazard condition is detected, and in instances where no hazard condition is detected, the process may loop back to the example step 304 for continuing and/or periodic monitoring. Returning to the example step 306, in instances where a hazard condition is detected, the process may proceed to example step 308.

In example step 308, alarm indications, pertaining to the detected hazard condition, may be generated. The alarm indications may comprise visual alarm indictors and/or audio alarm indicators.

In example step 310, information regarding detected hazard condition (and other related conditions) may be recorded, particularly in a protected data recorder, which may be specifically designed and/or implemented (as described with respect to FIG. 2, for example) to survive fires and/or other hazardous conditions so as to ensure that the information is not lost.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for an intelligent smoke sensor.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. An intelligent smoke detecting system for use in a network, the intelligent smoke detecting system comprising:
a sensor system configured to detect at least one of a plurality of predefined conditions;
a processor coupled to said sensor system, wherein the processor is configured to generate an alarm indication in response to said sensor system having detected at least one of said plurality of predefined conditions; and
a recorder coupled to said processor, wherein the recorder is configured to record said alarm indication and said detected at least one of said plurality of predefined conditions; and
a communication circuitry configured to communicate said alarm indication and said detected at least one of said plurality of predefined conditions to said network.

2. An intelligent smoke detecting system of claim 1, wherein said communication circuitry is further configured to communicate said alarm indication to a remote device coupled to said network.

3. An intelligent smoke detecting system of claim 2, wherein said remote device is configured to be activated in response to having received said alarm indication.

4. An intelligent smoke detecting system of claim 1, wherein said processor is further configured to perform a self malfunction test, and to generate a second alarm indication based on said self malfunction test.

5. An intelligent smoke detecting system of claim 1, wherein said sensor system comprises one or more of a plurality of photoelectric sensors and a plurality of temperature sensors.

6. An intelligent smoke detecting system of claim 1, further comprising a plurality of alarm indicators configured to indicate said alarm indication.

7. An intelligent smoke detecting system of claim 6, wherein said alarm indicators comprise one or more of a visual indicator and an audio indicator.

8. An intelligent smoke detecting system of claim 1, further comprising a housing having a plurality of microscopic holes configured to allow for smoke penetration.

9. An intelligent smoke detecting system for use in a network, the intelligent smoke detecting system comprising:
a device communicatively coupled to said network;
a network manager communicatively coupled to said device, and configured to communicate control signals via said network;
an intelligent smoke sensor communicatively coupled to said network manager via said network, the intelligent smoke sensor housing:
a sensor system configured to detect at least one of a plurality of predefined conditions;
a processor coupled to said sensor system, wherein the processor is configured to generate an alarm indication in response to said sensor system having detected at least one of said plurality of predefined conditions; and
a recorder coupled to said processor, wherein the recorder is configured to record said alarm indication and said detected at least one of said plurality of predefined conditions; and
a communication circuitry configured to communicate said alarm indication to said network manager via said network; and
wherein said network manager is further configured to communicate said control signals to said device in response to receiving said alarm indication, and
wherein said device is further configured to be activated in response to receiving said control signals.

10. An intelligent smoke detecting system of claim 9, wherein said intelligent smoke sensor further comprises an alarm indicator configured to indicate said alarm indication.

11. An intelligent smoke detecting system of claim 10, wherein said alarm indicators comprise one or more of a visual indicator and an audio indicator.

12. An intelligent smoke detecting system of claim 9, wherein said sensor system comprises one or more of a plurality of photoelectric sensors and a plurality of temperature sensors.

13. An intelligent smoke detecting system of claim 9, wherein said processor is further configured to perform a self malfunction test, and to generate a second alarm indication based on said self malfunction test.

14. An intelligent smoke detecting system of claim 9, wherein said intelligent smoke sensor further comprises a housing having a plurality of microscopic holes configured to allow said sensor system to detect said at least one of a plurality of predefined conditions.

15. A method of controlling a device via a) an intelligent smoke detecting system being remote from said device, and b) a network manager operable to communicate control signals to said device, the method comprising:
detecting at the intelligent smoke detecting system at least one of a plurality of predefined conditions;
in response to having detected said at least one of a plurality of predefined conditions, generating at said intelligent smoke detecting system an alarm indication;
recording at said intelligent smoke detecting system said alarm indication and said at least one of a plurality of predefined conditions;
communicating said alarm indication from said intelligent smoke detecting system to said network manager;
communicating said control signals from said network manager to said device in response to said network manager receiving said alarm indication; and
activating said device in response to receiving said control signals.

16. A method of claim 15, further comprising indicating said alarm indication with an alarm indicator.

17. A method of claim 16, wherein said alarm indicators comprise one or more of a visual indicator and an audio indicator, and the method further comprising indicating said alarm indication with one or more the visual indicator and the audio indicator.

18. A method of claim 15, further comprising performing a self malfunction test; and generating a second alarm indication based on said self malfunction test.

19. A method of claim 15, wherein detecting at said intelligent smoke detecting system at least one of a plurality of predefined conditions further comprises detecting at the intelligent smoke detecting system with one or more of a plurality of photoelectric sensors and a plurality of temperature sensors.

20. A method of claim 15, further comprising detecting said at least one of a plurality of predefined conditions through a plurality of microscopic holes located in a housing of said intelligent smoke detecting system.
